(19) United States
(12) Patent Application Publication
(10) Pub. No.: US 2014/0071533 A1
(43) Pub. Date: Mar. 13, 2014

(54) Transparent Conductive FILM And Touch Panel Provided With Same

(71) Applicants: TING-CHING KUO, Tao-Yuan (TW); JYR-DWO LEE, Tao-Yuan (TW); SHIH-LIANG CHOU, Tao-Yuan (TW); CHIEN-MIN WENG, Tao-Yuan (TW); TZU-WEN CHU, Tao-Yuan (TW)

(72) Inventors: TING-CHING KUO, Tao-Yuan (TW); JYR-DWO LEE, Tao-Yuan (TW); SHIH-LIANG CHOU, Tao-Yuan (TW); CHIEN-MIN WENG, Tao-Yuan (TW); TZU-WEN CHU, Tao-Yuan (TW)

(21) Appl. No.: 13/606,952

(22) Filed: Sep. 7, 2012

(51) Int. Cl. G02B 1/11

(52) U.S. Cl. 359/585

(57) ABSTRACT

The invention relates to a transparent conductive film. The transparent conductive film has a plastic film substrate, whose two surfaces are provided in sequence with at least two undercoat layers and a patterned transparent conductive layer, respectively. The invention overcomes the drawback of image deterioration caused by the patterning of the transparent conductive layers and reduces the optical difference between the patterned regions and the non-patterned regions by adjusting the refractive indexes and thicknesses of the various layers.

### BACKGROUND OF THE INVENTION

1. Field of the Invention

The present invention relates to a transparent conductive film and, more particularly, to a transparent conductive film adapted for use in a touch panel, in which the conventional drawback of image deterioration caused by the patterning of the transparent conductive layers is largely eliminated. The present invention also relates to a touch panel provided with the transparent conductive film.

2. Description of the Prior Art

With the advancement of touch-screen technology in recent years, touch panels have been widely used in a broad variety of electronic devices, including mobile phones, personal digital assistants (PDAs), input interfaces of game consoles, and computer touch-screens. In the actual practice, a touch panel is typically combined with a liquid crystal display (LCD) device to constitute a touch screen adaptable to various electronic devices, through which a user can conveniently input data and instructions without relying upon a traditional input device, such as a keyboard or a computer mouse.

In general, the transparent conductive glass used in a touch panel is primarily composed of a transparent, non-conductive glass substrate, on which a transparent material with high electrical conductivity, typically a transparent metal oxide such as indium tin oxide (ITO), is coated to form a transparent conductive layer. The transparent conductive layer is etched into a predetermined electrode pattern in the form of, for example, a unidirectional or bidirectional electrode array.

Therefore, the transparent conductive layer contains a patterned region (which is formed with electrodes) and a non-patterned region (the etched-away portion). The non-patterned region is not provided with ITO, allowing light to directly penetrate therethrough to reach the glass substrate. Since the patterned and non-patterned regions have substantially different refractive indexes, the user would notice the presence of the etch lines at the junctions between the patterned and non-patterned regions. As a result, images displayed on the screen are deteriorated due to the occurrence of discontinuity, haziness, granulation and low resolution in the images.

### SUMMARY OF THE INVENTION

An object of the invention is to provide a transparent conductive film and a touch panel provided with the same, in which the conventional drawback of image deterioration caused by the patterning of the transparent conductive layer is largely eliminated.

In order to achieve the object described above, the transparent conductive film according to the invention comprises a plastic film substrate having a first surface and a second surface opposite to the first surface. The first surface is provided in sequence with a first undercoat layer, a second undercoat layer and a first patterned transparent conductive layer, and the second surface is provided in sequence with a third undercoat layer, a fourth undercoat layer and a second patterned transparent conductive layer. The first, second, third and fourth undercoat layers have refractive indexes of N1, N2, N3 and N4, respectively, and have thicknesses of T1, T2, T3 and T4, respectively. The first and second patterned transparent conductive layers have refractive indexes of n1 and n2, respectively, and have thicknesses of t1 and t2, respectively, wherein n1≧N1>N2, n2≧N3>N4, and T2>t1>T1, T4>t2>T3.

In a preferred embodiment, the refractive indexes n1 and n2 of the first and second patterned transparent conductive layers are independently 2.0˜2.5, and the thicknesses t1 and t2 are independently 20˜35 nm.

In a preferred embodiment, the refractive indexes N1 and N3 of the first and third undercoat layers are independently 2.0˜2.5, and the thicknesses T1 and T3 are independently 7˜10 nm.

In a preferred embodiment, the refractive indexes N2 and N4 of the second and fourth undercoat layers are independently 1.4˜1.6, and the thicknesses T2 and T4 are independently 40˜55 nm.

In a preferred embodiment, the first and third undercoat layers are independently made of a niobium oxide (NbOₓ), a titanium oxide (TiOₓ) or a tantalum oxide (TaOₓ).

In a preferred embodiment, the second and fourth undercoat layers are made of silicon dioxide (SiO₂).

### BRIEF DESCRIPTION OF THE DRAWINGS

The above and other objects, features and effects of the invention will become apparent with reference to the following description of the preferred embodiments taken in conjunction with the accompanying drawing, in which:

FIG. 1 is a schematic cross-sectional diagram illustrating the structure of the transparent conductive film according to the invention.

### DETAILED DESCRIPTION OF THE PREFERRED EMBODIMENTS

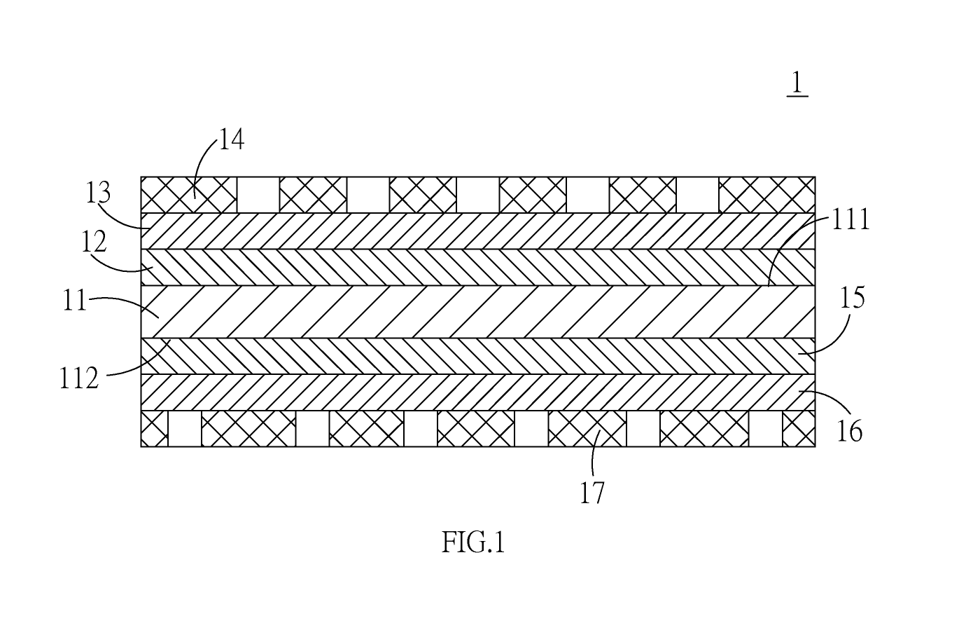

FIG. 1 is a schematic diagram illustrating the structure of the transparent conductive film according to the invention. As illustrated, the transparent conductive film disclosed herein comprises a plastic film substrate 11 having a first surface 111 and a second surface 112 opposite to the first surface 111. The first surface 111 is provided in sequence with a first undercoat layer 12, a second undercoat layer 13 and a first patterned transparent conductive layer 14. The second surface 112 is provided in sequence with a third undercoat layer 15, a fourth undercoat layer 16 and a second patterned transparent conductive layer 17. The first and second undercoat layers 12, 13 have refractive indexes of N1 and N2, respectively, and have thicknesses of T1 and T2, respectively, and the first patterned transparent conductive layer 14 has a refractive index of n1 and a thicknesses of t1, wherein n1≧N1>N2 and T2>t1>T1. The third and fourth undercoat layers 15, 16 have refractive indexes of N3 and N4, respectively, and have thicknesses of T3 and T4, respectively, and the second patterned transparent conductive layer 17 has a refractive index of n2 and a thicknesses of t2, wherein n2≧N3>N4 and T4>t2>T3.

The plastic film substrate used in the invention can be any type of plastic film that is transparent to light. The material from which the plastic film substrate is made is not critical under the spirit of the invention, which includes but is not limited to polyester resins, acetate resins, polyethersulfone resins, polycarbonate resins, polyamide resins, polyimide resins, polyolefin resins, methacrylate resins, polyvinylchloride resins, polyvinylidine chloride resins, polystyrene resins, polyvinyl alcohol resins, polyarylate resins, and polyphenylene sulfide resins. Preferred are polyester resins, polycarbonate resins and polyolefin resins. Advantageously, the plastic film substrate has a thickness ranging from 2 μm to 300 μm, preferably from 2 μm to 200 μm.

Before being built up with a series of layers, the plastic film substrate is preferably subjected to an aging treatment, for example, at 70° C. for 30 minutes. Afterwards, the plastic film substrate is provided on its two surfaces with the first and third undercoat layers, respectively, through a dry process, such as vacuum evaporation, sputtering and ion plating, or through a wet process, such as coating. Preferably, the first and third undercoat layers are independently made of a niobium oxide (NbOₓ), a titanium oxide (TiOₓ) or a tantalum oxide (TaOₓ), with the refractive indexes N1, N3 thereof being independently 2.0˜2.5 and the thicknesses T1, T3 thereof being independently 7˜10 nm.

The second and fourth undercoat layers are similarly provided atop the first and third prime coat layers, respectively, through a dry process, such as vacuum evaporation, sputtering and ion plating, or through a wet process, such as coating. Preferably, the second and fourth undercoat layers are made of silicon dioxide (SiO₂), with the refractive indexes N2, N4 thereof being independently 1.4˜1.6 and the thicknesses T2, T4 thereof being independently 40˜55 nm.

Next, first and second transparent conductive layers are provided atop the second and fourth undercoat layers, respectively, through a dry process, such as vacuum evaporation, sputtering and ion plating. The material from which the first and second transparent conductive layers are made is not critical under the spirit of the invention and preferably comprises an oxide of a metal selected from the group consisting of indium, tin, zinc, potassium, antimony, titanium, silicon, zirconium, magnesium, aluminum, gold, silver, copper, palladium and tungsten. Optionally, the material may further comprise one of the metals described above in its element form. Preferred are indium oxide blended with tin oxide, and tin oxide blended with antimony. Preferably, the first and second transparent conductive layers have a thickness of 20˜35 nm.

The first and second transparent conductive layers are then patterned into the first patterned transparent conductive layer 14 and the second patterned transparent conductive layer 17, each having a refractive index n1 or n2 ranging from 2.0 to 2.5 and a thickness t1 or t2 ranging from 20 to 35 nm. The patterning of the first and second transparent conductive layers results in patterned regions with any desired shape, such as a bar-like or block-like shape, and non-patterned regions. Optionally, the resultant first and second patterned transparent conductive layers are annealed at a temperature of 100˜200° C. for 30˜90 minutes, so as to have the layers crystallized.

The following Examples are given for the purpose of illustration only and are not intended to limit the scope of the present invention.

### Example 1

On opposite surfaces of a plastic film substrate, first and third undercoat layers (each being made of NbO and having a refractive index of 2.0) were provided in a thickness of 8 nm, respectively. The second and fourth undercoat layers (each being made of SiO₂ and having a refractive index of 1.46) were provided atop the first and third undercoat layers in a thickness of 50 nm, respectively. Then, first and second transparent conductive layers (each being made of ITO and having a refractive index of 2.1) were provided atop the second and fourth undercoat layers in a thickness of 30 nm, respectively, through a dry process, such as vacuum evaporation, sputtering and ion plating. Finally, the first and second transparent conductive layers were patterned into first and second patterned transparent conductive layers, resulting in the formation of patterned regions (provided with transparent conductive material ITO) and non-patterned regions (provided with no transparent conductive material).

### Comparative Example 2

Example 1 was repeated except that the second and fourth undercoat layers were fabricated in a thickness of 8 nm, respectively, and that the first and second transparent conductive layers were fabricated in a thickness of 50 nm, respectively.

### Comparative Example 3

Example 1 was repeated except that the first and third undercoat layers were made of SiO₂ (having a refractive index of 1.46) in a thickness of 8 nm, respectively, and the second and fourth undercoat layers were made of NbO (having a refractive index of 2.0) in a thickness of 50 nm, respectively.

### Comparative Example 4

Example 1 was repeated except that the first and third undercoat layers were made of SiO₂ (having a refractive index of 1.46) in a thickness of 50 nm, respectively, and the second and fourth undercoat layers were made of NbO (having a refractive index of 2.0) in a thickness of 8 nm, respectively.

The sample transparent conductive films fabricated in the Examples above were evaluated and the results were shown in Table 1 below.

<Surface Resistances of the Transparent Conductive Films>

The surface resistance values (Ω/□) of the ITO layers disposed on the respective transparent conductive films were measured using a two-terminal probe.

<Average Reflectance Over 400˜700 nm>

The reflection spectra of the respective transparent conductive films were obtained using a Hitachi U-4100 spectrophotometer equipped with an integrating sphere (Hitachi High Technologies Corp., San Jose, Calif., USA) at an incident angle of 10°, from which the average reflectance values over a wavelength range of 400˜700 nm were calculated.

<Visual Evaluation>

The respective sample transparent conductive films were placed on a black board and visually observed to evaluate whether the patterned regions and the non-patterned regions can be identified from each other.

⊚: Patterned regions can hardly be distinguished from non-patterned regions

x: Patterned regions can clearly be distinguished from non-patterned regions

TABLE 1

| | | | | | % Average Reflectance | | | |
|---|---|---|---|---|---|---|---|---|
| | | | | | over 400~700 nm | | | |
| | | | | Surface | | Non- | | |
| | T1, T3 | T2, T4 | t1, t2 | Resistance | Pattern | pattern | | Visual |
| | nm | | | Ω/□ | Regions | Regions | Difference | Evaluation |
| Example 1 | 8 | 50 | 30 | 150 | 11.66 | 11.43 | 0.23 | ⊚ |
| Comparative | 50 | 8 | 30 | 150 | 21.07 | 35.08 | 14.10 | X |
| Example 2 | | | | | | | | |
| Comparative | 8 | 50 | 30 | 150 | 26.68 | 35.21 | 8.53 | X |
| Example 3 | | | | | | | | |
| Comparative | 50 | 8 | 30 | 150 | 24.68 | 11.70 | 12.98 | X |
| Example 4 | | | | | | | | |

Table 1 shows that the transparent conductive film fabricated in Example 1, although experiencing a patterning process, can still exhibit a uniform visual appearance.

It is worthwhile to note that the transparent conductive film disclosed herein is suitable for use in a touch panel. The invention successfully overcomes the drawback of image deterioration caused by the patterning of the transparent conductive layers and reduces the optical difference between the patterned regions and the non-patterned regions by adjusting the refractive indexes and thicknesses of the various thin layers that constitute the transparent conductive film.

In conclusion, the transparent conductive film disclosed herein, as well as the touch panel provided with the same, can surely achieve the intended objects and effects of the invention by virtue of the processing steps described above. While the invention has been described with reference to the preferred embodiments above, it should be recognized that the preferred embodiments are given for the purpose of illustration only and are not intended to limit the scope of the present invention and that various modifications and changes, which will be apparent to those skilled in the relevant art, may be made without departing from the spirit of the invention and the scope thereof as defined in the appended claims.

What is claimed is:

1. A transparent conductive film, comprising:
a plastic film substrate having a first surface and a second surface opposite to the first surface;
wherein the first surface is provided in sequence with a first undercoat layer, a second undercoat layer and a first patterned transparent conductive layer, and the second surface is provided in sequence with a third undercoat layer, a fourth undercoat layer and a second patterned transparent conductive layer; and
wherein the first, second, third and fourth undercoat layers have refractive indexes of N1, N2, N3 and N4, respectively, and have thicknesses of T1, T2, T3 and T4, respectively, and wherein the first and second patterned transparent conductive layers have refractive indexes of n1 and n2, respectively, and have thicknesses of t1 and t2, respectively, and wherein n1≧N1>N2, n2≧N3>N4, and T2>t1>T1, T4>t2>T3.

2. The transparent conductive film according to claim 1, wherein the refractive indexes n1 and n2 of the first and second patterned transparent conductive layers are independently 2.0˜2.5, and the thicknesses t1 and t2 are independently 20˜35 nm.

3. The transparent conductive film according to claim 2, wherein the refractive indexes N1 and N3 of the first and third undercoat layers are independently 2.0˜2.5, and the thicknesses T1 and T3 are independently 7˜10 nm.

4. The transparent conductive film according to claim 3, wherein the refractive indexes N2 and N4 of the second and fourth undercoat layers are independently 1.4˜1.6, and the thicknesses T2 and T4 are independently 4˜55 nm.

5. The transparent conductive film according to claim 1, wherein the refractive indexes N1 and N3 of the first and third undercoat layers are independently 2.0˜2.5, and the thicknesses T1 and T3 are independently 7˜10 nm.

6. The transparent conductive film according to claim 1, wherein the first and third undercoat layers are independently made of a niobium oxide (NbOₓ), a titanium oxide (TiOₓ) or a tantalum oxide (TaOₓ).

7. The transparent conductive film according to claim 1, wherein the second and fourth undercoat layers are made of silicon dioxide (SiO₂).

8. A touch panel comprising the transparent conductive film defined in claim 1.

9. The touch panel according to claim 8, wherein the refractive indexes N1 and N3 of the first and third undercoat layers are independently 2.0˜2.5, and the thicknesses T1 and T3 are independently 7˜10 nm, and wherein the refractive indexes N2 and N4 of the second and fourth undercoat layers are independently 1.4˜1.6, and the thicknesses T2 and T4 are independently 40˜55 nm.

10. The touch panel according to claim 8, wherein the first and third undercoat layers are independently made of a niobium oxide (NbOₓ), a titanium oxide (TiOₓ) or a tantalum oxide (TaOₓ), and wherein the second and fourth undercoat layers are made of silicon dioxide (SiO₂).

11. A touch panel comprising the transparent conductive film defined in claim 2.

12. The touch panel according to claim 11, wherein the refractive indexes N1 and N3 of the first and third undercoat layers are independently 2.0˜2.5, and the thicknesses T1 and T3 are independently 7˜10 nm, and wherein the refractive indexes N2 and N4 of the second and fourth undercoat layers are independently 1.4˜1.6, and the thicknesses T2 and T4 are independently 40˜55 nm.

13. The touch panel according to claim 11, wherein the first and third undercoat layers are independently made of a niobium oxide (NbOₓ), a titanium oxide (TiOₓ) or a tantalum oxide (TaOₓ), and wherein the second and fourth undercoat layers are made of silicon dioxide (SiO₂).
